(19) United States
(12) Patent Application Publication
(10) Pub. No.: US 2016/0320554 A1
(43) Pub. Date: Nov. 3, 2016

(54) MODULAR DISTRIBUTION SYSTEM

(71) Applicant: 3M INNOVATIVE PROPERTIES COMPANY, Saint Paul, MN (US)

(72) Inventors: Andrew H. TILSTRA, Shoreview, MN (US); Jon A. KIRSCHHOFFER, Stillwater, MN (US); Scott E. SIMONS, Forest Lake, MN (US); Karl J. GEISLER, St. Paul, MN (US)

(21) Appl. No.: 15/104,374

(22) PCT Filed: Dec. 16, 2014
(86) PCT No.: PCT/US2014/070473

§ 371 Date: Jun. 14, 2016

Related U.S. Application Data
(60) Provisional application No. 61/918,371, filed on Dec. 19, 2013.

(51) Int. Cl. F21V 8/00; F21S 11/00

(52) U.S. Cl. CPC G02B 6/0096; F21S 11/007

(57) ABSTRACT

At least some aspects of the present disclosure feature a modular distribution system including a plurality of ducts connected in sequence and an attachment device configured to attach two adjacent ducts. At least one of the plurality of ducts includes a longitude axis, a plurality of coated panels, a plurality of rails disposed parallel to the longitude axis, each of the plurality of rails configured to receive the coated panels, and an end frame disposed generally perpendicular to the longitude axis and proximate one of the two ends of a coated panel.

### TECHNICAL FIELD

This disclosure is related to distribution systems having modular components. Some aspects of the present disclosure specifically relate to modular light distribution systems.

### SUMMARY

At least some aspects of the present disclosure feature is a modular lighting distribution system, comprising: a first light duct and a second light duct connected in sequence, and an attachment device configured to attach end frames of the first and the second light ducts. Each of the first and the second light ducts comprises a longitude axis, one or more coated panels, each coated panel having two sides and two ends, an interior surface, at least part of the interior surface is coated with a light reflective material, a rail disposed generally parallel to the longitude axis and configured to receive at least one of the two sides of a coated panel, and an end frame disposed generally perpendicular to the longitude axis and proximate one of the two ends of a coated panel.

At least some aspects of the present disclosure feature a modular distribution system, comprising: a plurality of ducts connected in sequence and an attachment device configured to attach end frames of two adjacent ducts. At least two of the plurality of ducts respectively includes a longitude axis, a plurality of coated panels, each coated panel having two sides and two ends, a plurality of rails disposed parallel to the longitude axis and configured to receive the plurality of coated panels, each of the plurality of rails having at least two recess traces, and an end frame disposed generally perpendicular to the longitude axis and proximate one of the two ends of a coated panel.

### BRIEF DESCRIPTION OF DRAWINGS

The accompanying drawings are incorporated in and constitute a part of this specification and, together with the description, explain the advantages and principles of the invention. In the drawings,

FIG. 1A is a perspective view of one embodiment of a modular distribution system;

FIG. 1B illustrates a cross sectional view of one embodiment of a rail;

FIGS. 1C and 1D illustrate perspective views of one embodiment of an end frame;

FIG. 1E illustrates a perspective view of another embodiment of a modular distribution system;

FIG. 1F illustrates a perspective view of one embodiment of an attachment device;

FIG. 2A shows a perspective schematic view of a lighting system;

FIG. 2B shows an exploded perspective schematic view of a lighting element;

FIG. 2C shows a perspective schematic view of a lighting element;

FIG. 2D shows a longitudinal cross-sectional schematic view of a lighting element;

FIG. 2E shows a cross-sectional schematic view of a lighting element;

FIG. 2F shows a schematic of a light ray path through a steering film;

FIG. 3A shows an exploded perspective schematic view of a lighting element;

FIG. 3B shows a perspective schematic view of one embodiment of a lighting element;

FIGS. 4A-4C show examples of cross-sectional schematic views of lighting elements;

FIGS. 5A-5C shows schematic plan views of lighting elements having different distributions of a plurality of voids; and

FIG. 6 shows a perspective schematic view of a troffer lighting element.

### DETAILED DESCRIPTION

At least some aspects of the present disclosure are directed to a modular distribution system using modular components to allow easy customizations for distributing various media, for example, light, air, or the like. In some implementations, the modular components include hollow enclosures and attachment devices to attach adjacent hollow enclosures. In some cases, the hollow enclosures, also referred to as ducts, can be formed by one or more generally flat panels and/or curved panels. The hollow enclosures can include one or more rails receiving the longitude sides of the panels and optionally include end frame(s) at one or both ends receiving the ends of the panels. In some other cases, the panels are coated or laminated with various materials to provide an efficient channel for transporting and distributing a specific medium. For example, a distribution system can use panels laminated with reflective sheets in light ducts to distribute lights. As another example, a distribution system can use panels laminated with thermal insulation sheets to distribute heated or cooled air.

Placing a source of light inside or close to an illuminated space or surface may be undesirable for a number of reasons including, for example: adverse effects on light sources and/or difficulty in servicing the lights sources at locations with excessive heat, radioactivity, noise, humidity, solvent vapor; locations with unfavorable weather conditions including solar, wind, dust, extreme temperature, corrosion, and salt; locations with unfavorable biological factors such as vermin, bugs, pollen, and vegetation; locations with unfavorable behavior such as prisons, psychiatric wards, vandalism; and locations with unfavorable accessibility, such as stadiums, transportation, schools, and streets. In some cases, light sources are preferably not placed at locations with access control, for example, surgical wards, industrial clean rooms, food preparation location, locations with bio-safety concerns, locations with safety and security limited access; regulatory limited spaces; height restricted areas; and cost-limited access including time saved by keeping a source in easily and quickly accessible place. Separation of a light source from the illuminated spaces may be achieved by placing a physical barrier, by distance, or by a combination of the two.

At least some aspects of the present disclosure describe light delivery and distribution components of a ducted lighting system and a light source. The delivery and distribution system (i.e., light duct, redistribution plate, and light duct extractor) can function effectively with any light source that is capable of delivering light which is substantially collimated about the longitudinal axis of the light duct, and which is also substantially uniform over the inlet of the light duct. Similar delivery and distributions systems have been described in, for example, U.S. Patent Application Ser. No. 61/810,294 entitled REMOTE ILLUMINATION LIGHT DUCT (Attorney Docket No. 72398US002), filed on Apr. 10, 2013.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

In one aspect, the present disclosure provides a light transport element and a lighting element that include a light duct having a longitudinal axis, a light duct cross-section perpendicular to the longitudinal axis, a reflective interior surface defining a cavity, and an exterior surface. The lighting element further includes a redistribution plate disposed perpendicular to the longitudinal axis for mixing and homogenizing an input light; a void disposed the reflective interior surface defining a light output surface, whereby light can exit the cavity; and a turning film disposed adjacent to the light output surface and exterior to the cavity, the turning film having parallel prismatic microstructures, each of the parallel prismatic microstructures having a vertex adjacent to the light output surface of the light duct.

The void in the reflective interior surface may be configured in a variety of shapes and sizes, including, but not limited to: a plurality of voids, each of a characteristic size at least four times smaller than the smallest dimension of the duct cross-section; one or more voids having a dimension larger than one-fourth of the smallest dimension of the duct cross-section but smaller than the dimension of the lighting element along its longitudinal axis; or a combination including at least one of each.

The distinction between the “light transport element” and the “lighting element” hereinafter is that the area of light output surface in the light transport element constitutes not more than 2% of the total area interior surface of the cavity defined by the reflective surface; in contrast, the area of light output surface in the lighting element constitutes more than 2% of the total area interior surface of the cavity defined by the reflective surface.

The lighting element may further include a steering film having a plurality of ridges adjacent to the turning film and opposite the light output surface, each ridge parallel to the longitudinal axis and disposed to refract an incident light ray from the turning film, wherein a light ray that exits the cavity through the light output surface is redirected by the turning film within a first plane perpendicular to the light duct cross-section, and further redirected by the steering film within a second plane parallel to the light duct cross section. Turning films, steering films, and plurality of void configurations are further described, for example, in co-pending PCT Publication Nos. WO2014/070495 entitled CURVED LIGHT DUCT EXTRACTION, and WO2014/070498 entitled RECTANGULAR LIGHT DUCT EXTRACTION, the disclosure of which are both herein incorporated in their entirety.

Any suitable reflector can be used in mirror-lined light ducts, including, for example metals or metal alloys, metal or metal alloy coated films, organic or inorganic dielectric films stack, or a combination thereof. In some cases, mirror-lined light ducts can be uniquely enabled by the use of polymeric multilayer interference reflectors such as 3M optical films, including mirror films such as Vikuiti™ ESR film, that have greater than 98% specular reflectivity across the visible spectrum of light. It is widely accepted that LED lighting may eventually replace a substantial portion of incandescent, fluorescent, metal halide, and sodium-vapor fixtures for remote lighting applications. One of the primary driving forces is the projected luminous efficacy of LEDs versus those of these other sources. Some of the challenges to utilization of LED lighting include (1) reduce the maximum luminance emitted by the luminaire far below the luminance emitted by the LEDs (e.g., to eliminate glare); (2) promote uniform contributions to the luminance emitted by the luminaire from every LED in the fixture (i.e., promote color mixing and reduce device-binning requirements); (3) preserve the small etendue of LED sources to control the angular distribution of luminance emitted by the luminaire (i.e., preserve the potential for directional control); (4) avoid rapid obsolescence of the luminaire in the face of rapid evolution of LED performance (i.e., facilitate updates of LEDs without replacement of the luminaire); (5) facilitate access to customization of luminaires by users not expert in optical design (i.e., provide a modular architecture); and (6) manage the thermal flux generated by the LEDs so as to consistently realize their entitlement performance without excessive weight, cost, or complexity (i.e., provide effective, light-weight, and low-cost thermal management).

When coupled to a collimated LED light source, the ducted light-distribution system described herein can address challenges (1)-(5) in the following manners (challenge 6 concerns specific design of the LED lighting element):

(1) The light flux emitted by the LEDs is emitted from the luminaire with an angular distribution of luminance which is substantially uniform over the emitting area. The emitting area of the luminaire is typically many orders of magnitude larger than the emitting area of the devices, so that the maximum luminance is many orders of magnitude smaller.

(2) The LED devices in any collimated source can be tightly clustered within an array occupying a small area, and all paths from these to an observer involve substantial distance and multiple bounces.

For any observer in any position relative to the luminaire and looking anywhere on the emitting surface of a luminaire, the rays incident upon your eye can be traced within its angular resolution backwards through the system to the LED devices. These traces will land nearly uniformly over the array due to the multiple bounces within the light duct, the distance travelled, and the small size of the array. In this manner, an observer's eye cannot discern the emission from individual devices, but only the mean of the devices.

(3) The typical orders of magnitude increase in the emitting area of the luminaire relative to that of the LEDs implies a concomitant ability to tailor the angular distribution of luminance emitted by the luminaire, regardless of the angular distribution emitted by the LEDs. The emission from the LEDs is collimated by the source and conducted to the emitting areas through a mirror-lined duct which preserves this collimation. The emitted angular distribution of luminance is then tailored within the emitting surface by the inclusion of appropriate microstructured surfaces. Alternately, the angular distribution in the far field of the luminaire is tailored by adjusting the flux emitted through a series of perimeter segments which face different directions. Both of these means of angular control are possible only because of the creation and maintenance of collimation within the light duct.

(4) By virtue of their close physical proximity, the LED sources can be removed and replaced without disturbing or replacing the bulk of the lighting system.

(5) Each performance attribute of the system is influenced primarily by one component. For example, the shape and size of the light transmissive region or, if used, the local percent open area of a perforated ESR spanning the light output region, determines the spatial distribution of emission, and the shape of optional decollimation-film structures (also referred to herein as “steering film” structures) largely determines the cross-duct angular distribution. It is therefore feasible to manufacture and sell a limited series of discrete components (e.g., slit or perforated ESR with a series of percent open areas, and a series of decollimation films for standard half angles of uniform illumination) that enable users to assemble an enormous variety of lighting systems.

One component of the light ducting portion of an illumination system is the ability to extract light from desired portions of the light duct efficiently, and without adversely degrading the light flux passing through the light duct to the rest of the ducted lighting system. Without the ability to extract the light efficiently, any remote lighting system would be limited to short-run light ducts only, which could significantly reduce the attractiveness of distributing high intensity light for interior lighting.

For those devices designed to transmit light from one location to another, such as a light duct, it is desirable that the optical surfaces absorb and transmit a minimal amount of light incident upon them while reflecting substantially all of the light. In portions of the device, it may be desirable to deliver light to a selected area using generally reflective optical surfaces and to then allow for transmission of light out of the device in a known, predetermined manner In such devices, it may be desirable to provide a portion of the optical surface as partially reflective to allow light to exit the device in a predetermined manner, as described herein.

Where multilayer optical film is used in any optical device, it will be understood that it can be laminated to a support (which itself may be transparent, opaque, reflective or any combination thereof) or it can be otherwise supported using any suitable frame or other support structure because in some instances the multilayer optical film itself may not be rigid enough to be self-supporting in an optical device.

Control of the emission in the cross-duct direction is available for curved light ducts whose cross section contains a continuum or discrete plurality of outward surface normals from the centerline of the light duct to points on the target illuminated surface(s). In some cases, the turning film can be rolled to form a cylinder and inserted into a smooth-walled transparent tube, with the apices of the prisms facing inward and their axes circumferential. Then the ESR having a predetermined light transmissive region can be rolled to form a cylinder and inserted inside the turning film. The emission through this light extraction duct is centered about normal to the surface, when the included angle of the parallel prism microstructures is about 69 degrees. Different circumferential locations on the surface of the light duct can illuminate different localized areas on the target surface. Tailoring the percent open area of the slit or perforated ESR at different locations to alter the local intensity of the emitted luminance provides the means to create desired patterns of illuminance on the target surface.

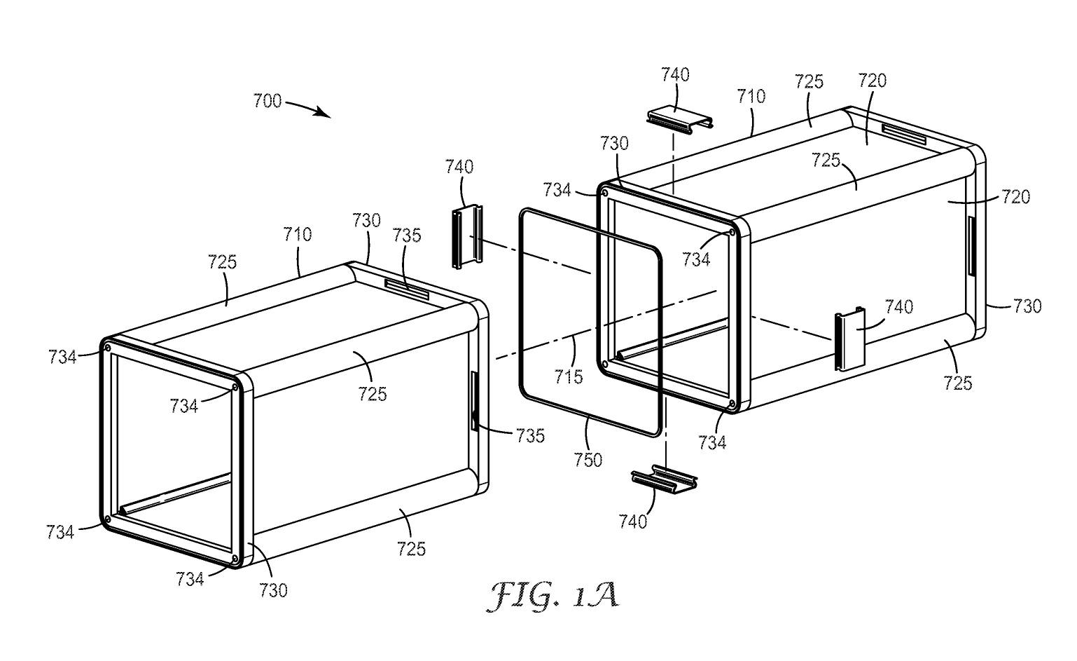

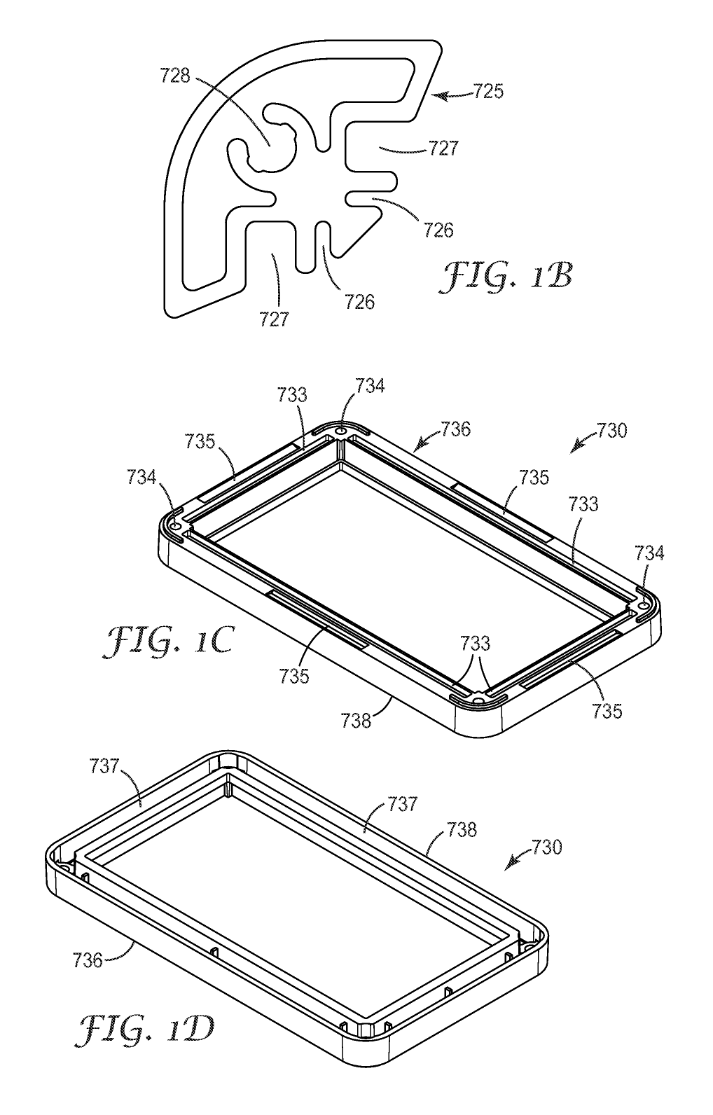

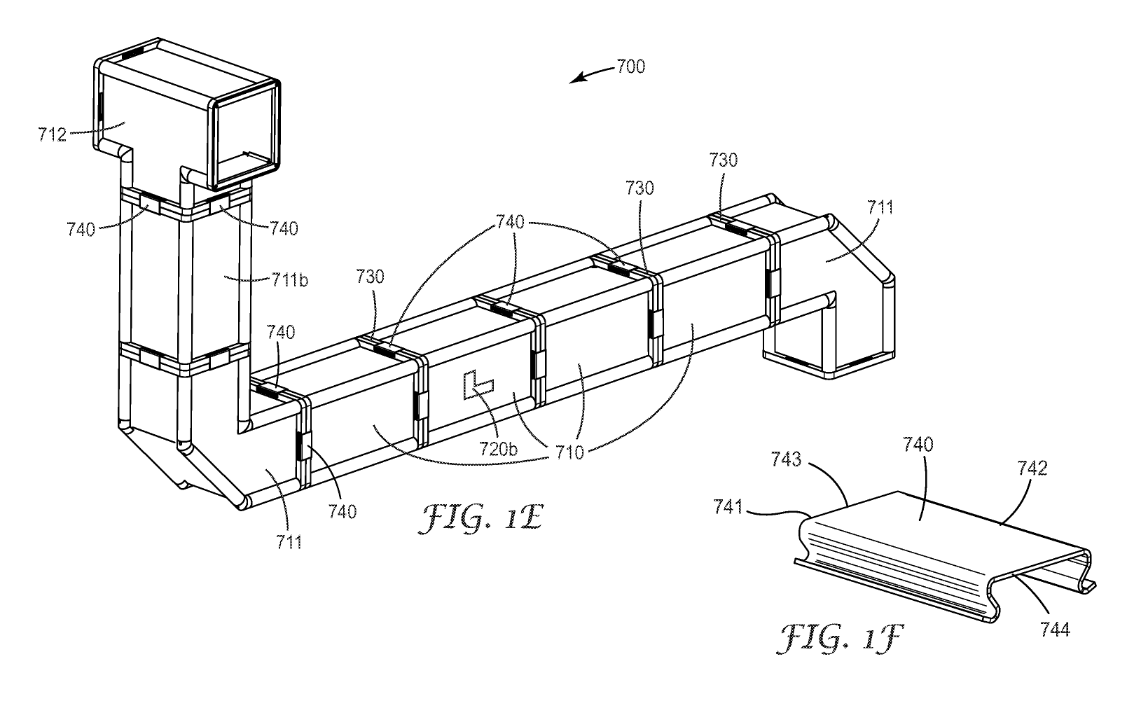

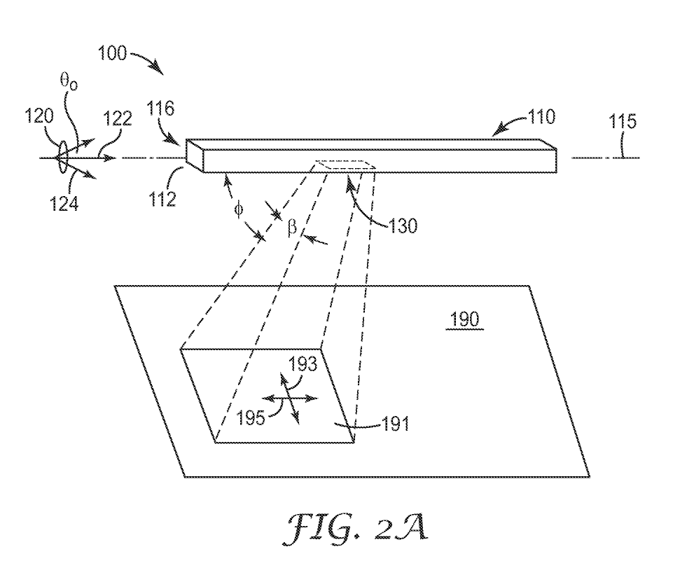

FIG. 1A is a perspective view of one embodiment of a modular distribution system 700. The system 700, as illustrated, includes ducts 710 and attachment devices 740, and optional sealing frame 750. The ducts 710 include panels 720, rails 725, and end frames 730. In this embodiment, the panel 720 is generally rectangular and has two sides and two ends. The rails 725 are configured to receive the sides of the panels 720 and the end frames 730 are configured to receive the ends of the panels 720. As illustrated, the end frames 730 and the cross-section of the ducts 710 are generally square or rectangular in shape. In some implementations, the end frames 730 and the cross-sections of the ducts 710 can have other shapes, for example, hexagon, polygon, circle, half circle, or the like. The duct 710 has a longitude axis, and the rails disposed generally parallel to the longitude axis. Each panel 720 is disposed between two rails 725. In the particular embodiment as illustrated, each duct 710 has four panels 720, four rails 725, and two end frames 730. Each of the rails 725 has at least two recess traces, each of the at least two recess traces is configured to receive a panel 720. The rails 725 can be made from rigid materials, for example, aluminum.

In some embodiments, the panels 720 include coated panels to improve efficiency for transporting the medium carried within the system, for example, aluminum panel coated with a reflective material. In some specific embodiments, the panels 720 can include panels laminated with one or more material layers, for example, reflective material layers, thermal insulation layers, or the like. The panels 720 can have one or more output regions to allow the transported medium to be distributed, for example, light output regions, air output regions, or the like. In some cases, an entire panel can function as an output region. The output region can use materials with properties suitable for emission the medium (e.g., transparent materials, materials with relative high air permeability, etc.) and/or mechanical structures (e.g., openings, apertures, holes, etc.) to allow distribution of the medium. In some cases, some of the output regions with different medium transmission rate from each other. For example, a duct closer to a medium source can have an output region with lower medium transmission rate than the transmission rate of an output region of a duct further away from the medium source.

In some embodiments, an end frame 730 is disposed generally perpendicular to the longitude axis 715 and proximate one of the two ends of the panel 720. In some cases, the end frame 715 has recess trace configured to receive the one of the two ends of the panel 720. The attachment device 740 is configured to attach the end frames 730 of two adjacent ducts 710. The end frame 730 can be affixed to the ducts using screws 734. In some implementations, the attachment device 740 is a spring clip having two edges and the end frame has a recess area for receiving an edge of the spring clip.

The optional seal frame 750 has a shape generally the same as the shape of the end frame 730 and the seal frame 750 is disposed between the end frames 730 of the adjacent ducts 710. The end frame and the seal frame can be made from, for example, polymeric materials, plastics, or the like. In some embodiments, the ducts 710 are light ducts suitable to transporting and distributing lights, and at least one of the ducts 710 include a light output region 722. In some implementations, one of the panels or part of the panel includes optical stacks discussed below to allow efficient light extraction and transmission. In some embodiments, a duct can have an output region that has a specific shape, for example, image(s), word(s), logo(s), or the like. In some other embodiments, a duct can have an output region that has a plurality of voids. In some cases, an output region can have one or more layers of materials, for example, a layer with a plurality of voids and a layer of material suitable for medium transmission. As an example, a light output region can be a transparent substrate with reflector film with a plurality of voids.

FIG. 1B illustrates a cross sectional view of one embodiment of a rail 725. The rail 725 has a few recess traces 726 and 727. The recess traces 726 and 727 can have the same width or different width. In some cases, the rails 725 have recess traces suitable for receiving panels with different thickness. For example, a panel laminated with light extraction film and light reflector film is thicker than a panel laminated with light reflector film. The rail 725 can also include a receiving structure 728 that is configured to receive screws.

FIGS. 1C and 1D illustrate perspective views of one embodiment of an end frame 730. In the embodiments as illustrated, the end frame 730 is general planar with two general surfaces 736 and 738. FIG. 1C has surface 736 facing up and FIG. 1D has surface 738 facing up. In some embodiments, the end frame 730 has recess traces 733 to receive ends of panels on the surface 736. In some cases, the recess traces 733 can have different width suitable to receive panels with different thickness on edges of the end frame 730. The end frame 730 can also include recess areas 735 configured to receive attachment devices and screw holes 734. On the surface 738, the end frame 730 can have a recess structure 737 that has generally the same size and same shape as the seal frame to allow tight fit.

FIG. 1E illustrates a perspective view of another embodiment of a modular distribution system 700 having ducts with various shapes. As illustrated, ducts 710 are generally rectangular tube shape, ducts 711 have the shape of elbow, and a duct 712 is in T-shape. In some implementations, while the ducts have various shapes, the ducts (e.g., 710, 711, and 712) have end frames 730 with same size and shape. The ducts can be attached to each other by attachment devices 740. In some cases that the ducts are light ducts, some of the ducts have no light output region and only transport light (e.g. the light duct 711b). In some other cases, some of the light ducts can have output regions different light transmission rates, for example, the one closer to the light source has lower light transmission rate than the one further away from the light source. In some embodiments, a light duct can have an output region (e.g. output region 720b) that has a special shape, for example, image(s), word(s), logo(s), or the like.

FIG. 1F illustrates a perspective view of one embodiment of an attachment device 740. The attachment device 740 has two sides 741 and 742 and two ends 743 and 744. Each of the two sides 741 and 742 can have a tightening structure slanted toward each other. In one embodiment, each of the sides 741 and 742 can be received by the recess area 735 of the end frame 730. In the embodiment as illustrated, the tightening structure is a V-shape structure. In some cases, an attachment device can be used as a tool to detach another attachment device. For example, an operator can attach the interior surface of the V-shape structure of an attachment device A to the exterior surface of the V-shape structure of an attachment device B that is attached to a duct, and then pull to detach the V-shape structure of the attachment device B from the duct.

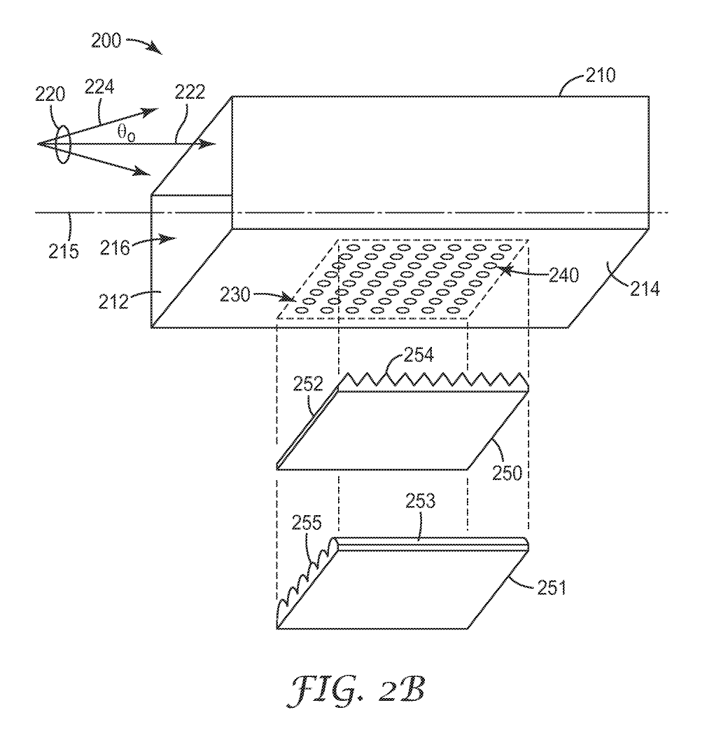

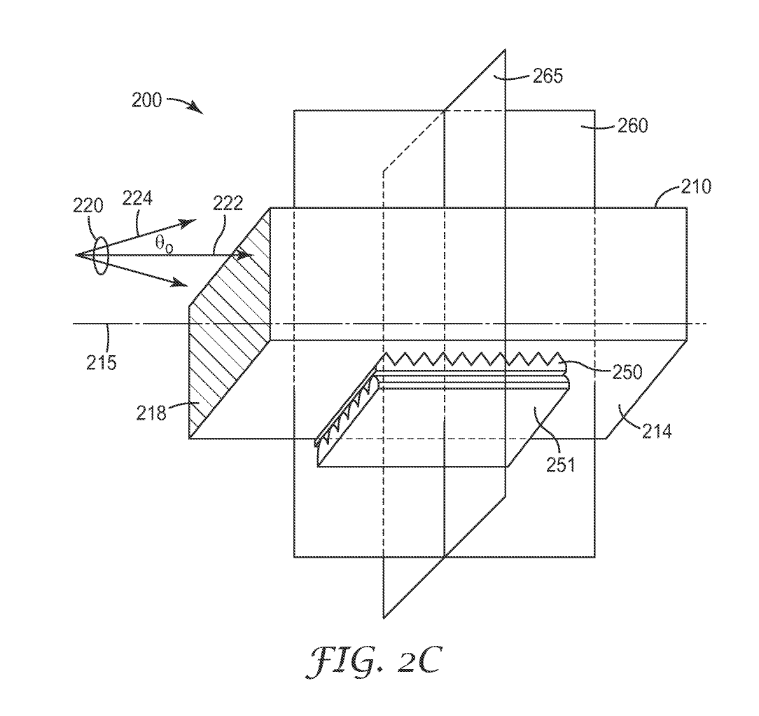

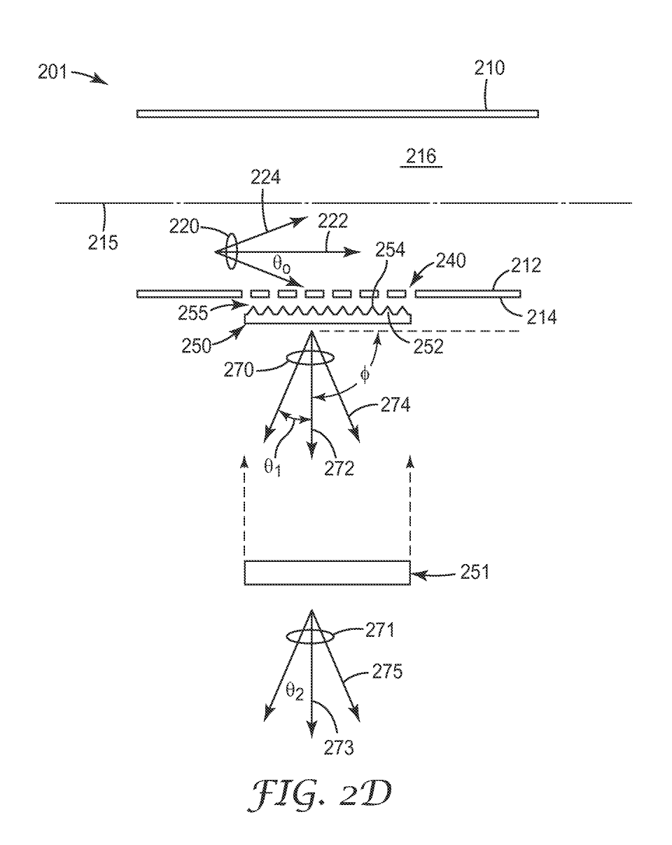

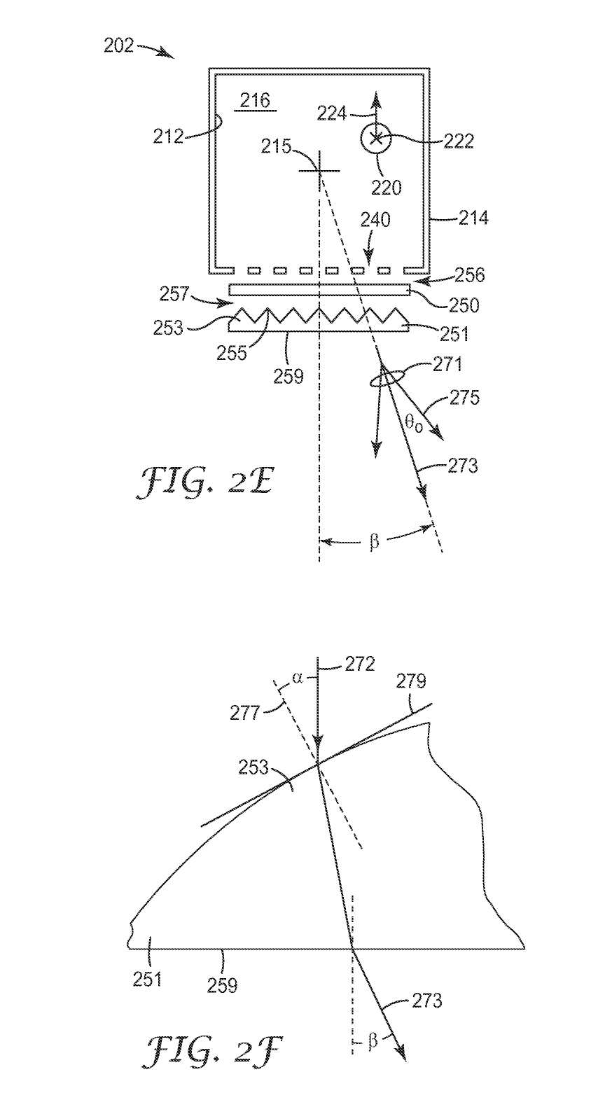

FIG. 2A shows a perspective schematic view of a lighting system 100, according to one aspect of the disclosure. Lighting system 100 includes a light duct 110 having a longitudinal axis 115 and a reflective inner surface 112 surrounding a cavity 116. A partially collimated light beam 120 having a central light ray 122 and boundary light rays 124 disposed within a collimation half-angle θ₀ of the longitudinal axis 115 can be efficiently transported along the light duct 110. A portion of the partially collimated light beam 120 can leave the light duct 110 through a light output surface 130 where light is extracted, as described elsewhere. In general, any desired number of light output surfaces can be disposed at different locations on any of the light ducts described herein. Light rays leaving the light output surface 130 are directed onto an illumination region 191 of an intercepting surface 190. The illumination region 191 can be positioned as desired on the intercepting surface 190, along a first direction 193 perpendicular to the longitudinal axis 115 and also along a second direction 195 parallel to the longitudinal axis 115. The size and shape of the illumination region 191 can also be varied, resulting in differing values of the radial output angle β and the longitudinal output angle φ from the light duct 110, as described elsewhere. The light rays that leave the light output surface 130 can be configured to create any desired level and pattern of illumination on the illumination region 191, as described elsewhere.

In one particular embodiment, partially collimated light beam 120 includes a cone of light having a propagation direction within an input light divergence angle θ₀ (i.e., a collimation half-angle θ₀) from central light ray 122. The divergence angle θ₀ of partially collimated light beam 120 can be symmetrically distributed in a cone around the central light ray 122, or it can be non-symmetrically distributed. In some cases, the divergence angle θ₀ of partially collimated light beam 120 can range from about 0 degrees to about 30 degrees, or from about 0 degrees to about 25 degrees, or from about 0 degrees to about 20 degrees, or even from about 0 degrees to about 15 degrees. In one particular embodiment, the divergence angle θ₀ of partially collimated light beam 120 can be about 23 degrees.

Partially collimated light rays are injected into the interior of the light duct along the direction of the axis of the light duct. A perforated reflective lining of the light duct (e.g., perforated 3M Enhanced Specular Reflector (ESR) film) lines the light duct. A light ray which strikes the ESR between perforations is specularly reflected and returned to the light duct within the same cone of directions as the incident light. Generally, the reflective lining of ESR is at least 98 percent reflective at most visible wavelengths, with no more than 2 percent of the reflected light directed more than 0.5 degrees from the specular direction. A light ray which strikes within a perforation passes through the ESR with no change in direction. (Note that the dimensions of the perforations within the plane of the ESR are assumed large relative to its thickness, so that very few rays strike the interior edge of a perforation.) The probability that a ray strikes a perforation and therefore exits the light duct is proportional to the local percent open area of the perforated ESR. Thus, the rate at which light is extracted from the light duct can be controlled by adjusting this percent open area.

The half angle in the circumferential direction is comparable to the half angle of collimation within the light duct. The half angle in the longitudinal direction is approximately one-half the half angle within the light duct; i.e., only half of the directions immediately interior to the ESR have the opportunity to escape through a perforation. Thus, the precision of directing the light in a desired direction increases as the half angle within the light duct decreases.

Light rays that pass through a perforation next encounter a prismatic turning film. The light rays strike the prisms of the turning film in a direction substantially parallel to the plane of the turning film and perpendicular to the axes of the prisms—the divergence of their incidence from this norm is dictated by the collimation within the light duct. A majority of these rays enter the film by refracting through the first prism face encountered, then undergoing total internal reflection (TIR) from the opposing face, and finally refract through the bottom of the film. There is no net change in the direction of propagation perpendicular to the axis of the light duct. The net change in direction along the axis of the light duct can be readily calculated by using the index of refraction of the turning film prism material and the included angle of the prisms. In general these are selected to yield an angular distribution of transmission centered about the downward normal to the film. Since most rays are transmitted, very little light is returned to the light duct, facilitating the maintenance of collimation within the light duct.

Light rays that pass through the turning film can next encounter a decollimation film or plate (also referred to as a steering film), as described elsewhere. The rays encountering the steering film strike the structured surface of this film substantially normal to the plane of the film. The majority of these pass through the structured surface, are refracted into directions determined by the local slope of the structure, and pass through the bottom surface. For these light rays, there is no net change in the direction of propagation along the axis of the light duct. The net change in direction perpendicular to the axis is determined by the index of refraction and the distribution of surface slopes of the structure. The steering film structure can be a smooth curved surface such as a cylindrical or aspheric ridge-like lens, or can be piecewise planar, such as to approximate a smooth curved lens structure. In general the steering film structures are selected to yield a specified distribution of illuminance upon target surfaces occurring at distances from the light duct large compared to the cross-duct dimension of the emissive surface. Again, since most rays are transmitted, very little light is returned to the light duct, preserving the collimation within the light duct.

In many cases the turning film and steering film, if present, may use a transparent support plate or tube surrounding the light duct (depending on the light duct configuration). In one particular embodiment, the transparent support can be laminated to the outermost film component, and can include an anti-reflective (AR) coating on the outermost surface. Both lamination and AR coats increase transmission through and decrease reflection from the outermost component, increasing the overall efficiency of the lighting system, and better preserving the collimation within the light duct.

FIG. 2B shows an exploded perspective schematic view of one embodiment of lighting element 200 that includes a rectangular light duct, according to one aspect of the disclosure. Each of the elements 210-230 shown in FIG. 2A correspond to like-numbered elements 110-130 shown in FIG. 2A, which have been described previously. For example, light duct 210 shown in FIG. 2B corresponds to light duct 110 shown in FIG. 2A, and so on. Lighting element 200 includes a light duct 210 having a longitudinal axis 215 and a reflective surface 212 surrounding a cavity 216. A partially collimated light beam 220 having a central light ray 222 and boundary light rays 224 disposed within an input collimation half-angle θ₀ of the longitudinal axis 215 can be efficiently transported along the light duct 210. A portion of the partially collimated light beam 220 can leave the light duct 210 through a plurality of voids 240 disposed in the reflective surface 212 in a light output surface 230 where light is extracted. A turning film 250 having a plurality of parallel ridged microstructures 252 is positioned adjacent to the light output surface 230 such that a vertex 254 corresponding to each of the parallel ridged microstructures 252 is positioned proximate an exterior surface 214 of light duct 210. The turning film 250 can intercept light rays exiting the cavity 216 through one of the plurality of voids 240.

A steering film 251 having a plurality of parallel ridges 253 each with a steering vertex 255, is positioned adjacent to the turning film 250 and opposite the light output surface 230 of the light duct 210. Each of the plurality of parallel ridges 253 positioned parallel to the longitudinal axis 215 of light duct 210, such that each of the plurality of parallel ridges 253 can refract light rays exiting the turning film 250 into a direction perpendicular to the longitudinal axis 215, such that a light ray that exits the cavity through the light output surface 230 is redirected into a first direction disposed within a first plane perpendicular to the light duct cross-section by the turning film, and into a second direction within a second plane parallel to the light duct cross section by the steering film, as described elsewhere.

In one particular embodiment, each of the plurality of voids 240 can be physical apertures, such as holes that pass either completely through, or through only a portion of the thickness of the reflective surface 212. In one particular embodiment, each of the plurality of voids 240 can instead be solid clear or transparent regions such as windows, formed in the reflective surface 212 that do not substantially reflect light. In either case, the plurality of voids 240 designates a region of the reflective surface 212 where light can pass through, rather than reflect from the surface. The voids can have any suitable shape, either regular or irregular, and can include curved shapes such as arcs, circles, ellipses, ovals, and the like; polygonal shapes such as triangles, rectangles, pentagons, and the like; irregular shapes including X-shapes, zig-zags, stripes, slashes, stars, and the like; and combinations thereof.

The plurality of voids 240 can be made to have any desired percent open (i.e., non-reflective) area from about 5% to about 95%. In one particular embodiment, the percent open area ranges from about 5% to about 60%, or from about 10% to about 50%. The size range of the individual voids can also vary, in one particular embodiment, the voids can range in major dimension from about 0.5 mm to about 5 mm, or from about 0.5 mm to about 3 mm, or from about 1 mm to about 2 mm.

In some cases, the voids can be uniformly distributed across the light output surface 230 and can have a uniform size. However, in some cases, the voids can have different sizes and distributions across the light output surface 230, and can result in a variable areal distribution of void (i.e., open) across the output region, as described elsewhere. The plurality of voids 240 can optionally include switchable elements (not shown) that can be used to regulate the output of light from the light duct by changing the void open area gradually from fully closed to fully open, such as those described in, for example, co-pending U.S. Patent Publication No. US2012-0057350 entitled, SWITCHABLE LIGHT-DUCT EXTRACTION.

The voids can be physical apertures that may be formed by any suitable technique including, for example, die cut, laser cut, molded, formed, and the like. The voids can instead be transparent windows that can be provided of many different materials or constructions. The areas can be made of multilayer optical film or any other transmissive or partially transmissive materials. One way to allow for light transmission through the areas is to provide areas in optical surface which are partially reflective and partially transmissive. Partial reflectivity can be imparted to multilayer optical films in areas by a variety of techniques.

In one aspect, areas may comprise multi-layered optical film which is uniaxially stretched to allow transmission of light having one plane of polarization while reflecting light having a plane of polarization orthogonal to the transmitted light, such as described, for example, in U.S. Pat. No. 7,147,903 (Ouderkirk et al.), entitled “High Efficiency Optical Devices”. In another aspect, areas may comprise multi-layered optical film, which has been distorted in selected regions, to convert a reflective film into a light transmissive film. Such distortions can be effected, for example, by heating portions of the film to reduce the layered structure of the film, as described, for example, in PCT Publication No. WO2010075357 (Merrill et al.), entitled “internally Patterned Multilayer Optical Films using Spatially Selective Birefringence Reduction”.

The selective birefringence reduction can be performed by the judicious delivery of an appropriate amount of energy to the second zone so as to selectively heat at least some of the interior layers therein to a temperature high enough to produce a relaxation in the material that reduces or eliminates a preexisting optical birefringence, but low enough to maintain the physical integrity of the layer structure within the film. The reduction in birefringence may be partial or it may be complete, in which case interior layers that are birefringent in the first zone are rendered optically isotropic in the second zone. In exemplary embodiments, the selective heating is achieved at least in part by selective delivery of light or other radiant energy to the second zone of the film.

In one particular embodiment, the turning film 250 can be a microstructured film such as, for example, Vikuiti™ Image Directing Films, available from 3M Company. The turning film 250 can include one plurality of parallel ridged microstructure shapes, or more than one different parallel ridged microstructure shapes, such as having a variety of included angles used to direct light in different directions, as described elsewhere.

FIG. 2C shows a perspective schematic view of the lighting element 200 of FIG. 2B, according to one aspect of the disclosure. The perspective schematic view shown in FIG. 2C can be used to further describe aspects of the lighting element 200. Each of the elements 210-250 shown in FIG. 2C correspond to like-numbered elements 210-250 shown in FIG. 2B, which have been described previously. For example, light duct 210 shown in FIG. 2C corresponds to light duct 210 shown in FIG. 2B, and so on. In FIG. 2C, a cross-section 218 of light duct 210 including the exterior 214 is perpendicular to the longitudinal axis 215, and a first plane 260 passing through the longitudinal axis 215 and the turning film 250 is perpendicular to the cross-section 218. In a similar manner, a second plane 265 is parallel to the cross-section 218 and perpendicular to both the first plane 260 and the turning film 250. As described herein, cross-section 218 generally includes a light output surface 230 disposed on a planar surface; in some cases, the light output surface 230 includes different planar segments of a planar-surface duct, as described elsewhere. Examples of some typical cross-section figures include triangles, squares, rectangles, pentagons, or other polygonal shapes.

The lighting element 200 further includes a steering film 251 disposed adjacent to the turning film 250, such that the turning film 250 is positioned between the steering film 251 and the exterior 214 of the light duct 210. The steering film 251 is disposed to intercept light exiting from the turning film 250 and provide angular spread of the light in a radial direction (i.e., in directions within second plane 265), as described elsewhere.

FIG. 2D shows a longitudinal cross-sectional schematic view of a lighting element 201 that includes a rectangular light duct extractor, according to one aspect of the disclosure. Lighting element 201 can be a cross-section of the lighting element 200 of FIG. 2C, along the first plane 260. Each of the elements 210-250 shown in FIG. 2D correspond to like-numbered elements 210-250 shown in FIG. 2C, which have been described previously. For example, light duct 210 shown in FIG. 2D corresponds to light duct 210 shown in FIG. 2C, and so on.

Lighting element 201 includes a light duct 210 having a longitudinal axis 215 and a reflective surface 212 surrounding a cavity 216. A partially collimated light beam 220 having a central light ray 222 and boundary light rays 224 disposed within an input collimation half-angle θ₀ of the longitudinal axis 215 can be efficiently transported along the light duct 210. A portion of the partially collimated light beam 220 can leave the light duct 210 through a plurality of voids 240 disposed in the reflective surface 212 in a light output surface 230 where light is extracted. A turning film 250 having a plurality of parallel ridged microstructures 252 is positioned adjacent to the light output surface 230 such that a vertex 254 corresponding to each of the parallel ridged microstructures 252 is positioned proximate an exterior surface 214 of light duct 210. In one particular embodiment, each vertex 254 can be immediately adjacent to the exterior surface 214; however, in some cases, each vertex 254 can instead be separated from the exterior surface 214 by a separation distance 255. The turning film 250 is positioned to intercept and redirect light rays exiting the cavity 216 through one of the plurality of voids 240.

The vertex 254 corresponding to each of the parallel ridged microstructures 252 has an included angle between planar faces of the parallel ridged microstructures 252 that can vary from about 30 degrees to about 120 degrees, or from about 45 degrees to about 90 degrees, or from about 55 degrees to about 75 degrees, to redirect light incident on the microstructures. In one particular embodiment, the included angle ranges from about 55 degrees to about 75 degrees and the partially collimated light beam 220 that exits through the plurality of voids 240 is redirected by the turning film 250 away from the longitudinal axis 215. The redirected portion of the partially collimated light beam 220 exits as a partially collimated output light beam 270 having a central light ray 272 and boundary light rays 274 disposed within an output collimation half-angle θ₁ and directed at a longitudinal angle φ from the longitudinal axis 215. In some cases, the input collimation half-angle θ₀ and the output collimation half angle θ₁ can be the same, and the collimation of light is retained. The longitudinal angle φ from the longitudinal axis can vary from about 45 degrees to about 135 degrees, or from about 60 degrees to about 120 degrees, or from about 75 degrees to about 105 degrees, or can be approximately 90 degrees, depending on the included angle of the microstructures.

A steering film 251 is positioned adjacent to the turning film 250 and opposite the light output surface 230 of the light duct 210 to intercept and refract the partially collimated output light beam 270. The partially collimated output light beam 270 exits the steering film 251 as a partially collimated steered light beam 271 having a central steered light ray 273 and boundary steered light rays 275 disposed within a steered collimation half-angle θ₂, as described elsewhere.

FIG. 2E shows a cross-sectional schematic view of a lighting element 202 that includes a rectangular light duct extractor, according to one aspect of the disclosure. Lighting element 202 can be a cross-section of the lighting element 200 of FIG. 2C, along the second plane 265. Each of the elements 210-250 shown in FIG. 2E correspond to like-numbered elements 210-250 shown in FIG. 2C, which have been described previously. For example, light duct 210 shown in FIG. 2E corresponds to light duct 210 shown in FIG. 2B, and so on.

Lighting element 202 includes a light duct 210 having a longitudinal axis 215 and a reflective surface 212 surrounding a cavity 216. A partially collimated light beam 220 having a central light ray 222 and boundary light rays 224 disposed within an input collimation half-angle θ₀ of the longitudinal axis 215 can be efficiently transported along the light duct 210, shown directed into the paper as shown in FIG. 2E. A portion of the partially collimated light beam 220 can leave the light duct 210 through a plurality of voids 240 disposed in the reflective surface 212 where light is extracted. A turning film 250 is positioned adjacent to the plurality of voids 240 as described with reference to FIG. 2C. The turning film 250 is positioned to intercept and redirect light rays exiting the cavity 216 through one of the plurality of voids 240, such that the redirection of light rays occurs in first plane 260 that passes through longitudinal axis 260. In one particular embodiment, the turning film 250 does not influence the path of light rays within the second plane 265 perpendicular to the longitudinal axis.

The path of light rays within the second plane 265, i.e. in radial directions about the longitudinal axis 215, is influenced by a steering film 251. The steering film 251 includes a planar output surface 259 and plurality of parallel ridges 253 each with a steering vertex 255, positioned adjacent to the turning film 250 and opposite the light output surface 230 of the light duct 210. In one particular embodiment, each steering vertex 255 can be immediately adjacent to the turning film 250; however, in some cases, each steering vertex 255 can instead be separated from the turning film 250 by a separation distance 257.

Each of the plurality of parallel ridges 253 can be positioned parallel to the longitudinal axis 215 of light duct 210, such that each of the plurality of parallel ridges 253 can refract light rays exiting the turning film 250 into a direction perpendicular to the longitudinal axis 215, such that a light ray that exits the cavity through the light output surface 230 is redirected into a first direction disposed within a first plane perpendicular to the light duct cross-section by the turning film, and into a second direction within a second plane parallel to the light duct cross section by the steering film.

In one particular embodiment, the partially collimated output light beam 270 exits the steering film 251 as a partially collimated steered light beam 271 having a central steered light ray 273 and boundary steered light rays 275 disposed within a steered collimation half-angle θ₂. A first component of the central steered light ray 273 is directed within the second plane 265 in a second direction at a radial angle β from the first plane 260. A second component of the central steered light ray 273 is directed within the first plane 260 in a first direction at a longitudinal angle φ from the longitudinal axis. In some cases, each of the input collimation half-angle θ₀, the output collimation half angle θ₁, and the steered collimation half-angle θ₂ can be the same, and the collimation of light is retained. The radial angle β around the longitudinal axis can vary from about 0 degrees to about ±90 degrees, or from about 0 degrees to about ±45 degrees, or from about 0 degrees to about ±30 degrees, of the light duct 210.

FIG. 2F shows a schematic of a light ray path through a steering film 251, according to one aspect of the disclosure. Each of the elements 251-273 shown in FIG. 2F correspond to like-numbered elements 251-273 shown in FIG. 2E, which have been described previously. For example, steering film 251 shown in FIG. 2F corresponds to steering film 251 shown in FIG. 2E, and so on. A central output light ray 272 from the turning film 250 of FIG. 2D travels in second plane 265 and intercepts one of the plurality of ridges 253 having a local tangent 279 and local normal 277 disposed at a local slope angle α to the first plane 260. Central output light ray 272 refracts through ridge 253, propagates through steering film 251, and refracts upon leaving through planar bottom surface 259 at a steering output angle β from first plane 260.

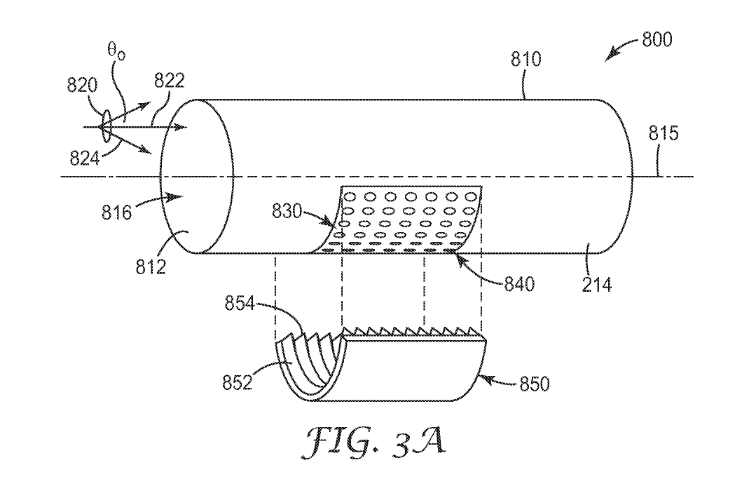

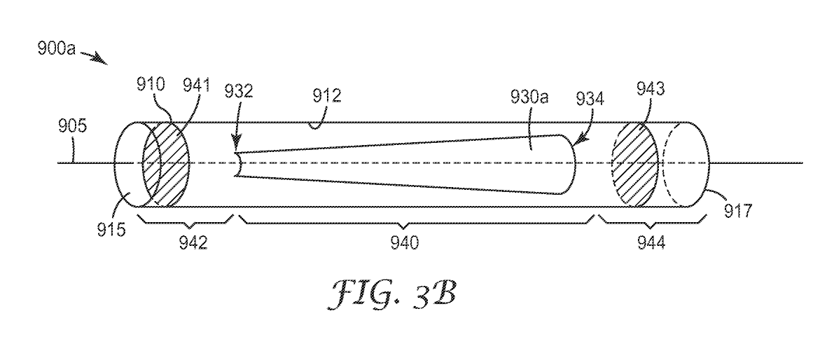

FIG. 3A shows an exploded perspective schematic view of one embodiment of a lighting element 800 that includes a cylindrical light duct, according to one aspect of the disclosure. Lighting element 800 includes a light duct 810 having a longitudinal axis 815 and a reflective surface 812 surrounding a cavity 816. A partially collimated light beam 820 having a central light ray 822 and boundary light rays 824 disposed within an input collimation half-angle θ₀ of the longitudinal axis 815 can be efficiently transported along the light duct 810. A portion of the partially collimated light beam 820 can leave the light duct 810 through a plurality of voids 840 disposed in the reflective surface 812 in a light output surface 830 where light is extracted. A turning film 850 having a plurality of parallel ridged microstructures 852 is positioned adjacent to the light output surface 830 such that a vertex 854 corresponding to each of the parallel ridged microstructures 852 is positioned proximate an exterior surface 814 of light duct 810. The turning film 850 can intercept light rays exiting the cavity 816 through one of the plurality of voids 840.

FIG. 3B shows a perspective schematic view of one embodiment of a lighting element 900, according to one aspect of the disclosure. The lighting elements 900 include a light duct 910 having a longitudinal axis 905, a first end 915, an opposing second end 917, and a reflective inner surface 912. The lighting element 900 further includes a light transmissive region 930 in a light output region 940. An optional light transport region 942, 944, extends between the light output region 940 and each of the first and second ends 915, 917, respectively. Each of the optional light transport regions 942, 944 comprise sections of the light duct 910 in which the reflective inner surface 912 extends completely around the light duct 910, with no accompanying light transmission region, to provide for transport and mixing of light (not shown) entering from either the first or second ends 915, 917.

Due to the relatively short transport region 942, 944, light entering the first or second end 915, 917, may not be fully mixed by the time it reaches the light output region 940, and light that exits the lighting element 900, may exhibit color and/or uniformity artifacts that tend to diminish over longer transport regions. For example, an LED having a phosphor coating and a lensed output can have a phosphor-colored “ring” of light that propagates down the longitudinal axis 905, and portions of the phosphor-colored ring may exit from the light output region 940 as a colored band of light. This non-uniformity of color can detract from the visual performance of the lighting element.

Inserting a redistribution plate 941, 943 in one or both of the optional light transport regions 942, 944 can help to reduce color and/or intensity non-uniformity of extracted light from the lighting element. The redistribution plate 941, 943, (also referred to herein as a “directional scrambler plate”) generally provides partial decollimation of the light in the path of collimated light before it enters the output region 940 of the light duct 910, and can reduce or eliminate color and/or intensity artifacts apparent in the relatively short light transport regions 942, 944, of the present invention. The redistribution plate can be positioned perpendicular to the longitudinal axis 905 of the lighting element 900a, 900b, 900c, or it can be positioned at an angle to the longitudinal axis 905. Redistribution plates suitable for use in the present disclosure include those made by the techniques described in, for example, co-pending U.S. Patent Application Ser. No. 61/826,577 (Attorney Docket No. 71463US002), filed on May 23, 2013.

An input light beam having light rays within an input collimation half-angle of an input central light ray (i.e., a first angular distribution of light rays), intersect the redistribution plate (or film), and are converted to an output light beam having light rays within an output collimation half-angle of an output central light ray (i.e., a second angular distribution of light rays). The redistribution plate can serve the function of mixing/blending of light from a single light source, or mixing/blending light from multiple light sources. The redistribution plate has a surface that includes an optimal slope distribution for reshaping the partially collimated incident light in order to match a prescribed distribution of transmitted light. For each combination of incident light input and desired light output, there is a family of surfaces that have a slope distribution suitable to effect the transformation; however, the optimal slope distribution most closely matches the desired light output.

The majority of the input light rays pass through the structured surface of the redistribution plate, are refracted into different directions determined by the local slope of the structure, and pass through the bottom surface in an output direction. For these light rays, there can be, if desired, no net change in the direction of propagation along the axis of the light duct; however, the structured surface can include microstructures such as tapered protrusions that can effect a change in the direction of propagation in two orthogonal directions. In some cases, the tapered protrusions can be complex shapes that include local slopes that are calculated by iterative, numerical, or analytical techniques in order to distribute the incident light in more complex output distribution. The net change in direction is determined by the index of refraction and the distribution of surface slopes of the structure. The decollimation film microstructure can include smooth- or irregular-curved surfaces similar to spherical or aspheric lenses, or can be piecewise planar, such as to approximate smooth curved lens structures, or can include diffuser characteristics, holographic characteristics, Fresnel characteristics, and the like. In general, the redistribution plate structures can be selected to yield a specified distribution of illuminance upon target surfaces occurring at distances from the light duct which are large compared to the cross-duct dimension of the emissive surface (i.e., the far-field image). Redistribution plate structures can also be selected to yield homogenization of the uniformity of both color and intensity of light passing through a light duct.

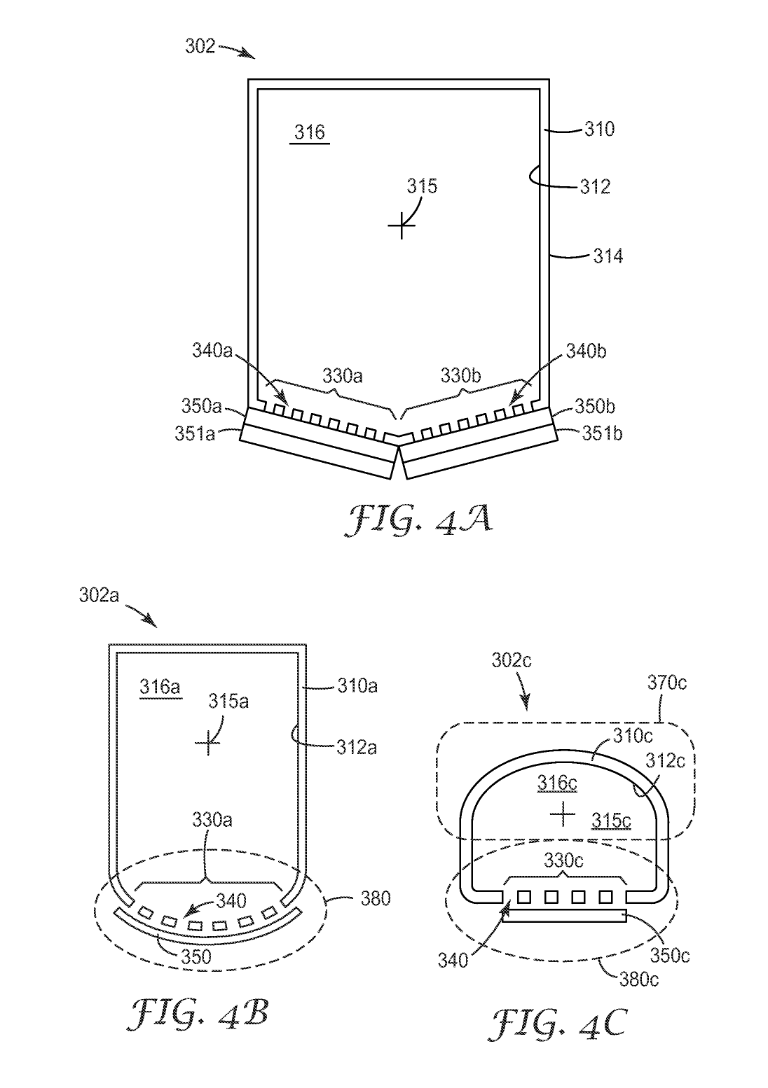

FIG. 4A shows a cross-sectional schematic of a light duct extractor having two planar output surfaces, according to one aspect of the disclosure. Each of the elements 310-351 shown in FIG. 4A correspond to like-numbered elements 210-251 shown in FIG. 2B, which have been described previously. For example, longitudinal axis 315 shown in FIG. 4A corresponds to longitudinal axis 215 shown in FIG. 2B, and so on.

In FIG. 4A, lighting element 302 includes a light duct 310 having a longitudinal axis 315, a reflective interior surface 312 surrounding a cavity 316, a first planar output surface 330a, and a second planar output surface 330b. The first and second planar output surfaces 330a, 330b, include a first and a second plurality of voids 340a, 340b, respectively. A first and a second turning film 350a, 350b, is disposed adjacent each of the first and second plurality of voids 340a, 340b. A first and a second optional steering film 351a, 351b, is disposed adjacent each of the first and second turning films 350a, 350b. In some cases, optional steering films 351a, 351b can be omitted, since the orientation of the first and second planar output surfaces 330a, 330b may be sufficient for directing the light where desired. The rectangular light duct 310a is representative of a variety of cross-sectional shapes including planar portions, and is intended to also represent other envisioned light duct cross-sections having planar portions including triangular, rectangular, square, pentagonal, and the like cross-sections.

In FIG. 4B, lighting element 302a includes a light duct 310a having a longitudinal axis 315a, a reflective interior surface 312a surrounding a cavity 316a, and a curved portion 380. The curved portion includes a plurality of voids 340 disposed in an output region 330a. A turning film 350 is disposed adjacent to the plurality of voids 340. The light duct 310a is representative of a variety of cross-sectional shapes including planar portions, and is intended to also represent other envisioned light duct cross-sections having planar portions including triangular, rectangular, square, pentagonal, and the like cross-sections.

In FIG. 4C, lighting element 302c includes a light duct 310c having a longitudinal axis 315c, a reflective interior surface 312c surrounding a cavity 316c, and a light output region 330d 380c. The light duct 310c has an arched portion 370c and a flat portion 380c. The flat portion 380c includes a plurality of voids 340 disposed in the light output region 330d. A turning film 350c is disposed adjacent to the plurality of voids 340.

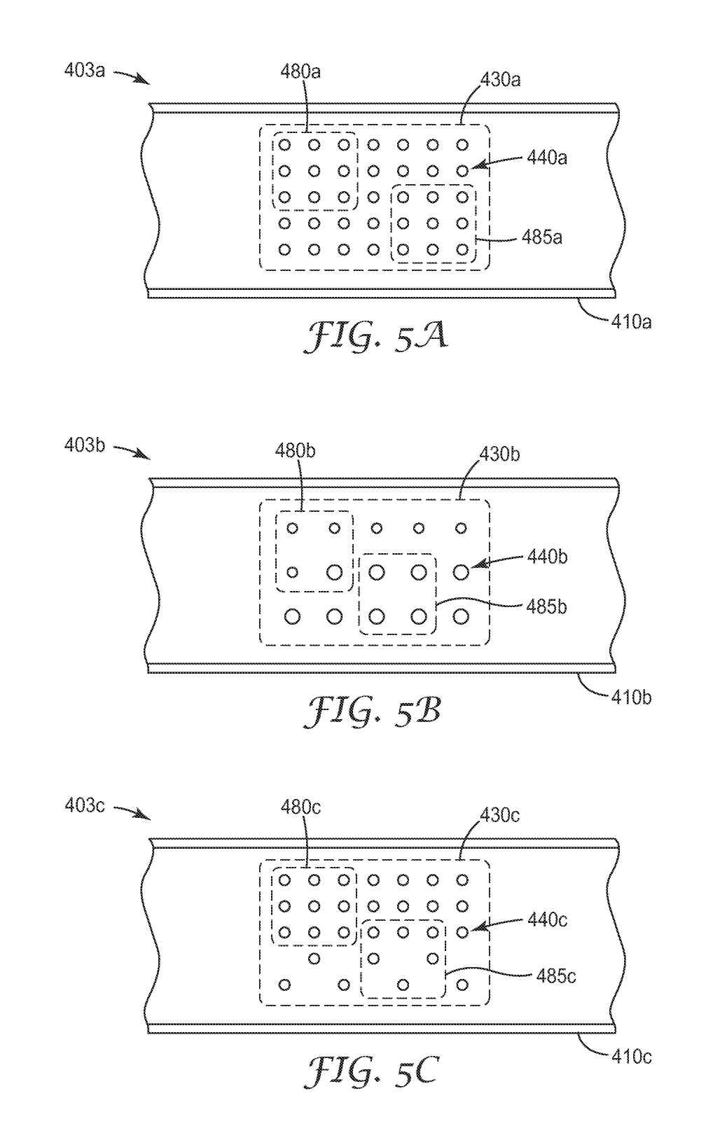

FIGS. 5A-5C shows schematic plan views of duct extractors having different distributions of a plurality of voids, according to one aspect of the disclosure. It is to be understood that any desired distribution of sizes of voids, shapes of voids, and relative positions of voids are encompassed by the disclosure, and the plan views provided in FIGS. 5A-5C are provided for illustrative purposes only. In FIG. 5A, an element 403a includes a duct 410a having an output region 430a and a plurality of uniform sized voids 440a disposed within the output region 430a. An areal density of voids can be defined as the total area of voids (i.e., regions where medium can leave the duct 410a) within a predetermined area of the output region. In one particular embodiment, the plurality of uniform sized voids 440a can be uniformly distributed throughout the output region 430a such that a first areal density of voids 480a is equal to a second areal density of voids 485a displaced from the first areal density of voids 480a.

In FIG. 5B, an element 403b includes a duct 410b having an output region 430b and a plurality of non-uniform sized voids 440b disposed within the output region 430b. In one particular embodiment, the plurality of non-uniform sized voids 440b can be distributed throughout the output region 430b such that a first areal density of voids 480b is smaller than a second areal density of voids 485b displaced from the first areal density of voids 480b.

In FIG. 5C, an element 403c includes a duct 410c having an output region 430c and a plurality of uniform sized voids 440c disposed within the output region 430c. In one particular embodiment, the plurality of uniform sized voids 440c can be distributed throughout the output region 430c such that a first areal density of voids 480c is greater than a second areal density of voids 485c displaced from the first areal density of voids 480c. As illustrated, the output regions 430a, 430b, 430c can have different medium transmission rates using different sizes, shapes, and/or patterns of voids. In some cases, output regions can have different medium transmission rates using voids made from materials with different transmission properties.

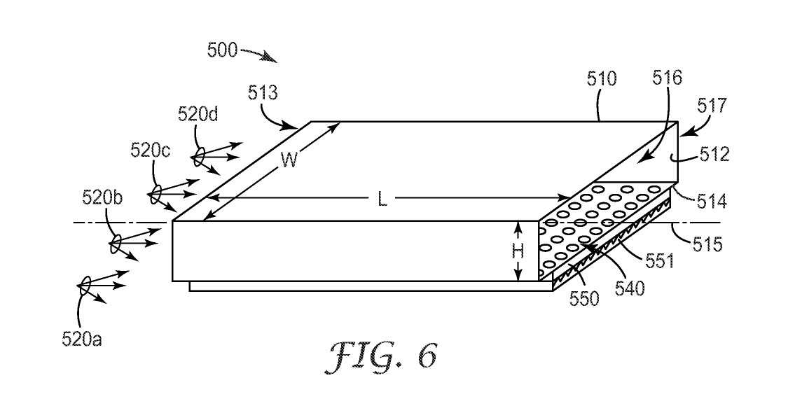

FIG. 6 shows a perspective schematic view of a troffer lighting element 500, according to one aspect of the disclosure. Each of the elements 510-551 shown in FIG. 6 correspond to like-numbered elements 210-251 shown in FIG. 2C, which have been described previously. For example, longitudinal axis 515 shown in FIG. 6 corresponds to longitudinal axis 215 shown in FIG. 2C, and so on. The troffer lighting element 500 can be considered to be a short, shallow, and wide application of a rectangular light duct 200 as shown in FIGS. 2B-2E; i.e., the length L and width W of the troffer lighting element 500 are comparably sized (i.e., L˜W), whereas the rectangular light duct 200 typically will have a length L several times (e.g., 8 times or more) greater than the largest dimension in the cross section (i.e., L≧8W). Typical uses for the troffer lighting element 500 are as discrete ceiling-mounted luminaires, and troffers often include multiple light sources to provide for uniform illumination, although solitary light sources can also be used.

Troffer lighting element 500 includes a light duct 510 having a longitudinal axis 515 and a reflective surface 512 surrounding a cavity 516. A plurality of partially collimated light beams 520a-520d similar to the partially collimated light beam 220 of FIG. 2C can be injected into a first end 513 of the light duct 510, and a reflector (not shown) can be placed at a second end 517 of the light duct to redirect the path of light reaching the second end 517 back into the cavity 516, thereby efficiently transporting light throughout the light duct 210. A portion of the partially collimated light beams 520a-520d can leave the light duct 510 through a plurality of voids 540 disposed in the reflective surface 512 in a light output surface where light is extracted. A turning film 550 is positioned adjacent to the light output surface proximate an exterior surface 514 of light duct 510. The turning film 550 can intercept light rays exiting the cavity 516 through one of the plurality of voids 540.

A steering film 551 is positioned adjacent to the turning film 550 and opposite the exterior surface 514 of the light duct 510. The turning film 550 and steering film 551 are positioned in a manner similar to the description provided in FIGS. 2B-2E, such that a light ray that exits the cavity through the plurality of voids 540 is redirected into a first direction disposed within a first plane perpendicular to the light duct cross-section by the turning film, and into a second direction within a second plane parallel to the light duct cross section by the steering film, as described elsewhere.

One of ordinary skill in the art would readily recognize that in one particular embodiment, the steering film 551 and the turning film 550 of the troffer lighting element 500 can include a two-dimensional steering film 551 that incorporates the functions of each, i.e., both turning and steering the extracted partially collimated light beam in two orthogonal directions. In some cases, this can be accomplished by forming three-dimensional microstructures on the two-dimensional steering film 551.

Formulas can be readily derived that form the basis for an approximate analytic model of the angular distribution of luminance transmitted by the rectangular light extractor, and its dependence upon the half angle of collimation within the light duct, the index and included angle of the turning film, and the index and slope distribution of the steering film. The impacts of ray paths other than the principal path, subtle differences in index between the resins, substrates, and support plates within the curved light extractor, the potential for absorption within these components, and the presence of additional features such as the anti-reflective (AR) coat on the support plate can all be assessed by photometric ray-trace simulation. Predictions of well-executed simulations can be essentially exact insofar as the input descriptions of components and their assembly are accurate.

Generally, the half angle in the along-duct direction of the emission through any lighting element of the form depicted in FIGS. 2-5 is approximately one-half the half angle of the collimation within the light duct, since typically only one-half of the rays within the cone of rays striking the void will exit the light duct. In some cases, it can be desirable to increase the half angle in the along-duct direction without altering the angular distribution emitted in the cross-duct direction. Increasing the half angle in the along-duct direction will elongate the segment of the emissive surface which makes a substantive contribution to the illuminance at any point on a target surface. This can in turn diminish the occurrence of shadows cast by objects near the surface, and may reduce the maximum luminance incident upon the surface, reducing the potential for glare. It generally is not acceptable to increase the half angle along the light duct by simply increasing the half angle within the light duct, as this would alter the cross-duct distribution and ultimately degrade the precision of cross-duct control.

For example, the along-duct distribution is centered approximately about normal for index—1.6, 69-degree turning prisms. It is centered about a direction with a small backward component (relative to the sense of propagation within the light duct) for included angles less than 69 degrees, and about a direction with a forward component for included angles greater than 69 degrees. Thus, a turning film composed of prisms with a plurality of included angles, including some less than 69 degrees and some greater than 69 degrees, can produce an along-duct distribution approximately centered about normal, but possessing a larger along-duct half angle than a film composed entirely of 69-degree prisms.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

### Exemplary Embodiments

Embodiment 1 is a modular lighting distribution system, comprising: a first light duct and a second light duct connected in sequence, each of the first and the second light ducts comprising: a longitude axis, one or more coated panels, each coated panel having two sides and two ends, an interior surface, at least part of the interior surface is coated with a light reflective material, a rail disposed generally parallel to the longitude axis and configured to receive at least one of the two sides of a coated panel, and an end frame disposed generally perpendicular to the longitude axis and proximate one of the two ends of a coated panel; and an attachment device configured to attach the end frames of the first and the second light ducts.

Embodiment 2 is the modular lighting distribution system of Embodiment 1, wherein the attachment device is a spring clip having two edges, wherein the end frame has an recess area for receiving an edge of the spring clip.

Embodiment 3 is the modular lighting distribution system of Embodiment 1 or Embodiment 2, wherein one of the one or more coated panels of each of the first and the second light ducts has a light output region, and wherein the light output regions of the first and the second light ducts have different light transmission rates from each other.

Embodiment 4 is the modular lighting distribution system of Embodiment 3, wherein the light output region of one of the one or more coated panels of each of the first and the second light ducts comprises a pattern of voids.

Embodiment 5 is the modular lighting distribution system of any one of the previous Embodiments, wherein each of the first and the second light ducts comprises four coated panels.

Embodiment 6 is the modular lighting distribution system of Embodiment 5, wherein one of the four coated panels has a light output region.

Embodiment 7 is the modular lighting distribution system of any one of the previous Embodiments, wherein one of the one or more coated panels of the first light duct has a light output region and none of the one or more coated panel of the second light duct has a light output region.

Embodiment 8 is the modular lighting distribution system of any one of the previous Embodiments, wherein one of the one or more coated panels of the first light duct has a light output region that is shaped as an image.

Embodiment 9 is the modular lighting distribution system of any one of the previous Embodiments, wherein one of the one or more coated panels of the first light duct has a light output region that is shaped as one or more words.

Embodiment 10 is the modular lighting distribution system of any one of the previous claims, further comprising a seal frame having a shape generally the same as the shape of the end frame, wherein the seal frame is disposed between the end frames of the first and the second light ducts.

Embodiment 11 is the modular lighting distribution system of any one of the previous Embodiments, further comprising: a redistribution plate disposed perpendicular to a longitudinal axis of the first light duct and adjacent to one of the end frame.

Embodiment 12 is the modular lighting distribution system of Embodiment 2, further comprising:

a turning surface disposed adjacent to the light output region of the first light duct, the turning surface comprising parallel ridged microstructures.

Embodiment 13 is a modular distribution system, comprising: a plurality of ducts connected in sequence, at least two of the plurality of ducts respectively comprising: a longitude axis, a plurality of coated panels, each coated panel having two sides and two ends, a plurality of rails disposed parallel to the longitude axis and configured to receive the plurality of coated panels, each of the plurality of rails having at least two recess traces, and an end frame disposed generally perpendicular to the longitude axis and proximate one of the two ends of a coated panel; and an attachment device configured to attach the end frames of two adjacent ducts.

Embodiment 14 is the modular distribution system of Embodiment 13, wherein the attachment device is a spring clip having two edges, wherein the end frame has an recess area for receiving an edge of the spring clip.

Embodiment 15 is the modular distribution system of Embodiment 13 or Embodiment 14, wherein the end frame has a recess trace configured to receive the one of the two ends of the coated panel.

Embodiment 16 is the modular distribution system of any one of Embodiment 13 to Embodiment 15, further comprising: a seal frame having a shape generally the same as the shape of the end frame, wherein the seal frame is disposed between the end frames of the two adjacent ducts.

Embodiment 17 is the modular distribution system of any one of Embodiment 13 to Embodiment 16, wherein the plurality of coated panels include a panel laminated with a reflective material layer.

Embodiment 18 is the modular distribution system of any one of Embodiment 13 to Embodiment 17, wherein the plurality of coated panels include a panel laminated with a thermal insulation layer.

Embodiment 19 is the modular distribution system of any one of Embodiment 13 to Embodiment 18, wherein at least one of the plurality of ducts includes an output region.

Embodiment 20 is the modular distribution system of any one of Embodiment 13 to Embodiment 19, wherein the plurality of ducts include at least two output regions, and wherein two of the at least two output regions have different medium transmission rate from each other.

Embodiment 21 is the modular distribution system of any one of Embodiment 13 to Embodiment 20, wherein a recess trace of a rail is configured to receive one of the two sides of a coated panel.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A modular lighting distribution system, comprising:
a first light duct and a second light duct connected in sequence, each of the first and the second light ducts comprising:
a longitude axis,
one or more coated panels, each coated panel having two sides and two ends,
an interior surface, at least part of the interior surface is coated with a light reflective material,
a rail disposed generally parallel to the longitude axis and configured to receive at least one of the two sides of a coated panel, and
an end frame disposed generally perpendicular to the longitude axis and proximate one of the two ends of a coated panel; and
an attachment device configured to attach the end frames of the first and the second light ducts.

2. The modular lighting distribution system of claim 1, wherein the attachment device is a spring clip having two edges, wherein the end frame has an recess area for receiving an edge of the spring clip.

3. The modular lighting distribution system of claim 1, wherein one of the one or more coated panels of each of the first and the second light ducts has a light output region, and wherein the light output regions of the first and the second light ducts have different light transmission rates from each other.

4. The modular lighting distribution system of claim 3, wherein the light output region of one of the one or more coated panels of each of the first and the second light ducts comprises a pattern of voids.

5. The modular lighting distribution system of claim 1, wherein each of the first and the second light ducts comprises four coated panels.

6. The modular lighting distribution system of claim 5, wherein one of the four coated panels has a light output region.

7. The modular lighting distribution system of claim 1, wherein one of the one or more coated panels of the first light duct has a light output region that is shaped as an image or one or more words.

8. The modular lighting distribution system of claim 1, further comprising:
a seal frame having a shape generally the same as the shape of the end frame,
wherein the seal frame is disposed between the end frames of the first and the second light ducts.

9. The modular lighting distribution system of claim 1, further comprising:
a redistribution plate disposed perpendicular to a longitudinal axis of the first light duct and adjacent to one of the end frame.

10. The modular lighting distribution system of claim 2, further comprising:
a turning surface disposed adjacent to the light output region of the first light duct, the turning surface comprising parallel ridged microstructures.

11. A modular distribution system, comprising:
a plurality of ducts connected in sequence, at least two of the plurality of ducts respectively comprising:
a longitude axis,
a plurality of coated panels, each coated panel having two sides and two ends,
a plurality of rails disposed parallel to the longitude axis and configured to receive the plurality of coated panels, each of the plurality of rails having at least two recess traces, and
an end frame disposed generally perpendicular to the longitude axis and proximate one of the two ends of a coated panel; and
an attachment device configured to attach the end frames of two adjacent ducts.

12. The modular distribution system of claim 11, wherein the attachment device is a spring clip having two edges, wherein the end frame has an recess area for receiving an edge of the spring clip.

13. The modular distribution system of claim 11, wherein the end frame has a recess trace configured to receive the one of the two ends of the coated panel.

14. The modular distribution system of claim 11, wherein the plurality of coated panels include a panel laminated with a reflective material layer.

15. The modular distribution system of claim 11, wherein the plurality of ducts include at least two output regions, and wherein two of the at least two output regions have different medium transmission rate from each other.
